(19) United States
(12) Patent Application Publication
(10) Pub. No.: US 2022/0314773 A1
(43) Pub. Date: Oct. 6, 2022

(54) POWER SUPPLY ASSEMBLY FOR A MOTOR VEHICLE

(71) Applicant: Renault S.A.S., Boulogne-Billancourt (FR)

(72) Inventors: Benoit ARSAC, Versailles (FR); Christian G. GAUTHIER, Les Clayes Sous Bois (FR); Laura HERICHER, La Ville du Bois (FR); Mikel LARRABEITI-JAUREGI, Valladolid (FR); Sebastien ROUDIER, Massy (FR)

(73) Assignee: Renault S.A.S., Boulogne-Billancourt (FR)

(21) Appl. No.: 17/639,292

(22) PCT Filed: Sep. 4, 2020
(86) PCT No.: PCT/EP2020/074803

§ 371 Date: Feb. 28, 2022

(30) Foreign Application Priority Data
Sep. 10, 2019 (FR) 1909924

(51) Int. Cl. B60K 1/04; H01M 50/209; H01M 50/264

(52) U.S. Cl. CPC B60K 1/04; H01M 50/209; H01M 50/264; B60K 2001/0416; H01M 2220/20

(57) ABSTRACT

A power supply assembly includes: a casing having a base and at least two side walls; and a set of battery modules. Each of the modules includes a battery having two opposing ends, and two opposing flanges covering the ends. The modules are installed on the base in a plurality of rows of modules arranged in line with one another. The rows are arranged such that the flanges are aligned edge to edge. The aligned flanges are joined to the base of the casing so as to form rigid cross members inside the casing.

The present invention relates to an electrical power supply assembly for a motor vehicle.

One envisioned field of application is in particular that of electric motor vehicles or even hybrid vehicles, of which the electrical power supply assembly is on board.

Thus, the electrical power supply assembly of a hybrid vehicle is generally installed beneath the rear trunk of the vehicle. It comprises a casing having a bottom and four walls that are opposite one another in pairs and protrude upright from the bottom: two lateral walls, one rear wall and one front wall. It also comprises a set of accumulator battery modules, which is arranged inside the casing. Each of the modules of the set has an accumulator battery having two opposite ends, and two opposite flanges respectively covering the ends. The accumulators are for example prismatic lithium accumulators installed in series between the two flanges.

The modules of the set are installed inside the casing on the bottom in a plurality of contiguous rows of n modules. The n modules are situated coaxially in the extension of one another and substantially parallel to the lateral walls. Also, they are electrically coupled in series.

The casings equipped with the set of modules have to provide resistance to deformation and pass the impact tests or “crash tests”. Therefore, to do this, reinforcing crossmembers are installed across the casing between the modules and perpendicular to the lateral walls. They then extend from one lateral wall to the other so as to mechanically connect them and to make the casing more rigid. However, these reinforcing crossmembers are installed to the detriment of the space reserved for the accumulator battery modules, and consequently for the quantities of electrical energy that can be stored.

Thus, installing reinforcing elements outside the casing has been imagined, but always to the detriment of the space reserved for the accumulator batteries. Reference can be made to document CN101209659A, which describes such reinforcing elements.

Thus, one problem that arises and that the present invention aims to solve is that of providing an electrical power supply assembly for a motor vehicle offering good resistance to deformation without, however, compromising the quantity of energy that can be stored and the ease of integration in the vehicle, nor excessively increasing the weight and bulk, both inside and outside the casing.

With the aim of solving this problem, an electrical power supply assembly for a motor vehicle is proposed, comprising: a casing having a bottom and at least two lateral walls that are opposite one another and protrude upright from said bottom; and a set of accumulator battery modules, each of the modules of said set having an accumulator battery having two opposite ends, and two opposite flanges respectively covering said ends, the modules of said set being installed inside said casing on said bottom in a plurality of contiguous rows of n modules situated coaxially in the extension of one another and substantially parallel to said lateral walls. Said contiguous rows are arranged such that the flanges of the modules of said rows are respectively aligned edge to edge in a direction substantially perpendicular to said opposite lateral walls; and said aligned flanges are secured to said bottom of said casing so as to form rigid crossmembers inside said casing.

Thus, one characteristic of the invention resides in the particular arrangement of the modules of the rows such that the flanges are fitted edge to edge and also aligned in a direction perpendicular to the lateral walls, and that in addition the flanges are secured to the bottom of the casing. In other words, the structure of the modules themselves is put to use, so as to form crossmembers with the flanges then making it possible to make the casing more rigid. Indeed, since the flanges are fitted edge to edge in a direction perpendicular to the lateral walls and, in addition, secured to the bottom of the casing, they constitute a rigid element capable of withstanding compression, as will be explained in more detail in the remainder of the description.

In this way, there is no need to install auxiliary crossmembers and therefore the casing is reserved only for the installation of the accumulator battery modules and it is nevertheless rigid so as to be able to resist deformation and pass the impact tests.

According to a particularly advantageous embodiment of the invention, the modules of each of said rows are connected together in pairs by just a single flange. In this way, for each of the rows, two accumulator batteries are connected by a single flange, and therefore, with respect to a given row length with modules each having two flanges, a larger quantity of accumulators is accommodated.

Also, said modules of said set of modules advantageously have just a single length. In this way, all the flanges of the modules can be aligned edge to edge inside the casing and can thus constitute reinforcing crossmembers after they have been secured in the bottom of the casing. In addition, it is easier to fill all the available space in the casing, the dimensions of which are provided depending on the modules.

Preferentially, said casing has a front wall and an opposite rear wall, protruding upright from said bottom and respectively connecting said lateral walls substantially perpendicularly so as to close said casing. In this way, the stiffness of the casing is further increased.

Furthermore, each of said flanges advantageously has a given thickness and at least one through-orifice made in said thickness so as to allow a fastening screw to pass through. Preferentially, the flanges have two parallel orifices made in their thickness allowing two fastening screws to pass through for perfect securing of the flange and the bottom of the casing.

Thus, according to a particularly advantageous embodiment of the invention, said bottom of said casing has tapped portions for receiving the screws for fastening said flanges. Thus, the tapped portions are made in the bottom of the casing in predefined positions in order to accommodate the set of accumulator battery modules. After the modules have been fitted in the casing, the screws are then inserted into the orifices in the flanges so that they can be screwed into the tapped portions and the flanges can thus be detached at the bottom of the casing.

According to a variant embodiment, said bottom of said casing comprises tapped collars for receiving said fastening screws. In this way, when the thickness of the bottom of the casing is relatively small, these help to anchor the screws in the bottom, for better securing.

Also, according to this variant embodiment, said flanges advantageously have recesses in the extension of said through-orifices so as to be able to accommodate said collars. In this way, there is no free space in the casing and the ratio between the electrical power that can be stored due to the accumulator batteries and the total space defined by the casing is optimal.

Preferentially, each of said flanges has a substantially rectangular parallelepipedal shape. In this way, the flanges aligned flank against flank can butt against one another and thus provide perfect longitudinal compressive strength.

Furthermore, each of said flanges is preferentially molded in one piece from aluminum alloy. In this way, reinforcing crossmembers with an advantageous weight/strength ratio are formed.

Further particular features and advantages of the invention will become apparent upon reading the description provided below of particular embodiments of the invention, which are given by way of nonlimiting indication, with reference to the appended drawings, in which:

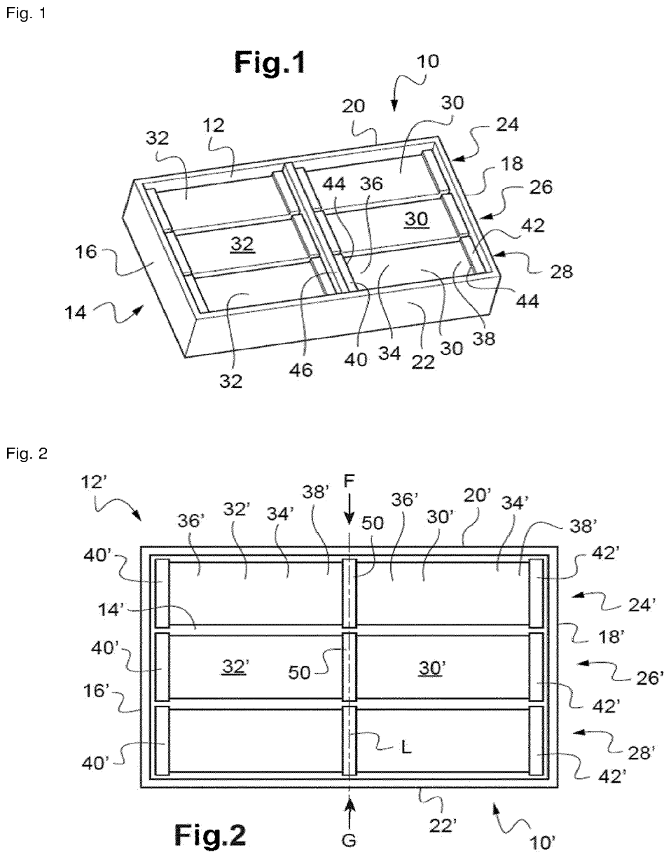

FIG. 1 is a schematic perspective view of an electrical power supply assembly in accordance with the prior art;

FIG. 2 is a schematic top view of an electrical power supply assembly according to the invention in accordance with a first embodiment;

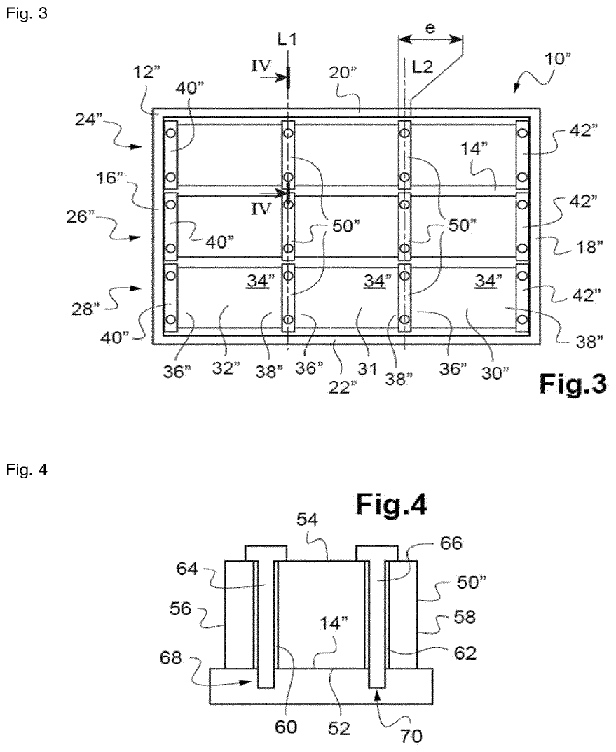

FIG. 3 is a top view of an electrical power supply assembly according to the invention in accordance with a second embodiment;

FIG. 4 is a schematic detail view in section on the plane IV-IV in the figure FIG. 3 in accordance with a variant embodiment; and,

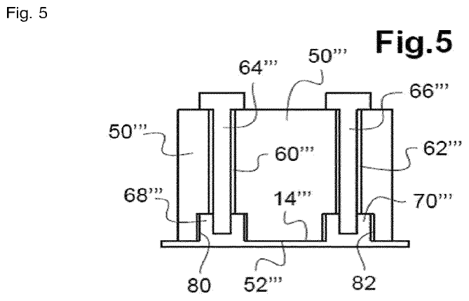

FIG. 5 is a schematic detail view in section on the plane IV-IV in the figure FIG. 3 in accordance with another variant embodiment.

FIG. 1 shows a first electrical power supply assembly 10 in accordance with the prior art. It comprises a first casing 12 having a first bottom 14, a first front wall 16, a first rear wall 18 and two opposite first lateral walls 20, 22 connected to the first front 16 and rear 18 walls. Also, the first casing 12 has a rectangular overall shape and the opposite first lateral walls 20, 22 have a length greater than that of the first front 16 and rear 18 walls.

The electrical power supply assembly 10 has three contiguous first rows 24, 26, 28 of two first accumulator battery modules, a first first module 30 and a second first module 32.

Each first accumulator battery module 30, 32 has a first accumulator battery 34 having two opposite first ends 36, 38 and two opposite first flanges, a first first flange 40 and a second first flange 42 respectively covering the two opposite first ends 36, 38. The flanges 40, 42 have in their flanks a cutout corresponding to the cross section of the opposite ends 36, 38 of the accumulator battery 34, so as to be able to be engaged therein. Also, the first accumulator batteries 34 of the first modules 30, 32 of each of the first rows 24, 26, 28 are respectively electrically coupled to one another.

The first accumulator battery 34 is of rectangular section and it is made of a succession of prismatic accumulators applied against one another and electrically coupled in series. They are thus kept applied against one another by way of the first flanges 40, 42. The first flanges 40, 42 are identical and have a rectangular parallelepipedal shape. Their section is substantially greater than that of the accumulator battery 34 and, around their cutout, a lip forms a shoulder 44 that extends around the opposite first ends 36, 38.

Also, despite the electrical coupling, the first first modules 30 and the second first modules 32 of the three first rows 24, 26, 28 are separated from one another by a crossmember 46 extending from one lateral wall 20 to the other 22 and over the entire height of the casing 12.

The crossmember 46 makes it possible to reinforce the casing 12 and thus to provide better resistance to deformation when, during an impact, the two opposite lateral walls 20, 22 are forcibly driven in compression toward one another.

However, the crossmember 46 makes it necessary to reserve a space that is then a wasted space for the accumulator batteries and consequently for the energy storage capacities of the electrical power supply assembly.

Also, a second casing 12′ will be described with reference to the figure [FIG. 2] and according to a first variant embodiment of the subject matter of the invention. The elements of the subject matter of the figure [FIG. 2] that are identical or have the same function as that in the figure [FIG. 1] will bear the same reference followed by a “′” symbol.

The second casing 12′ includes three contiguous second rows 24′, 26′, 28′ of two second accumulator battery modules, a first second module 30′ and a second second module 32′. The second casing 12′ of rectangular overall shape is identical to the first casing 12 and it has a second bottom 14′, a second front wall 16′, a second rear wall 18′ and two opposite second lateral walls 20′, 22′ connected to the second front 16′ and rear 18′ walls.

It will be observed first of all that the casing 12′ has no crossmember and that, since the first and second second modules 30′ and 32′ each have a second accumulator battery 34′ having two opposite second ends 36′, 38′, the two second ends 38′, 36′ that are next to one another are connected together by just a single intermediate flange 50. This intermediate flange 50 covers, on each side, the two second ends 38′, 36′ of the two second accumulator batteries 34′. Also, the intermediate flange 50 has, in its two opposite flanks, a cutout corresponding to the section of the opposite second ends 36′, 38′ of the accumulator battery 34′ so as to receive them therein.

The other two second ends 36′, 38′, which are opposite one another, of the two second accumulator batteries 34′ of the first second row 24′ of second modules 30′, 32′ respectively receive second flanges 40′, 42′. These second flanges 40′, 42′ are respectively next to the second front 16′ and rear 18′ walls.

Also, with a second casing 12′ of which the length is equal to that of the first casing 12, it is understood that by replacing two flanges with an intermediate flange 50 and by removing the crossmember 46, there is a greater length available for inserting second modules 30′, 32′, of which the second accumulator batteries 34′ specifically include more accumulators.

It will be observed that the two second flanges 40′, 42′ and the intermediate flange 50 have a cross section identical to that of the first flanges 40, 42 shown in the figure [FIG. 1].

Furthermore, the other two second rows 26′ and 28′ are completely analogous to the first 24′. And consequently, the intermediate flanges 50 of the other two second rows 26′ and 28′ extend edge to edge and along a single line L. In addition, the two second flanges 40′, 42′ of the other two second rows 26′ and 28′ are also respectively aligned edge to edge.

Therefore, by fastening the three intermediate flanges 50, which are aligned edge to edge, of the three second rows 24′, 26′ and 28′ to the second bottom 14′ of the second casing 12′, a transverse element forming a rigid central crossmember is then formed.

In this way, it is understood that the stresses that would be exerted simultaneously toward one another on the opposite lateral walls 20′, 22′ along the arrows F, G, during an impact, would be opposed and resisted by the rigid central crossmember.

In addition, it is also possible to fasten the two second flanges 40′, 42′ of the three second rows 24′, 26′ and 28′ to the second bottom 14′ so as to form two other auxiliary crossmembers that are symmetric to one another relative to the rigid central crossmember, respectively along the second front 16′ and rear 18′ walls.

Reference will now be made to the figure [FIG. 3] illustrating an electrical power supply assembly 10″ according to a second embodiment. There will also be described in detail the method of fastening the flanges according to two variant embodiments.

This figure [FIG. 3] thus shows a third casing 12″ including three contiguous third rows 24″, 26″, 28″ of three third accumulator battery modules; at one end, a first third module 30″, in the center, a second third module 31 and at the other end, a third third module 32″. The third modules 30″, 31, 32″ of each of the three contiguous third rows 24″, 26″, 28″ are respectively situated in the extension of one another.

The third casing 12″ has a third bottom 14″, a third front wall 16″, a third rear wall 18″ and two opposite third lateral walls 20″, 22″ connected to the third front 16″ and rear 18″ walls.

The third modules 30″, 31 and 32″ each have a third accumulator battery 34″ having two opposite third ends 36″, 38″.

The two times two second ends 38″, 36″ that are respectively next to one another, of each of the three third rows 24″, 26″, 28″, are respectively connected together by only two second intermediate flanges 50″. These second intermediate flanges 50″ cover, respectively, the two second ends 38″, 36″ of the three third accumulator batteries 34″. Thus, three third accumulator batteries 34″ extend in the continuation of one another and are connected to each other by way of the intermediate flanges 50″ and thus form the three modules 30″, 31, 32″ as a single longitudinal block.

The two third ends 36″, 38″, which are opposite one another, of the two third accumulator batteries 34′ of the two third end modules 32″, 30″ respectively receive two third flanges 40″, 42″.

Also, the two third flanges 40″, 42″ and the two intermediate flanges 50″ have a cross section identical to that of the first flanges 40, 42 shown in the figure [FIG. 1].

Furthermore, the other two third rows 26″ and 24″ are completely analogous to the first 28″. And consequently, the three times two intermediate flanges 50″ of the other two third rows 26″ and 24″ extend respectively edge to edge and along two parallel lines L1 and L2. In addition, the two third flanges 40″, 42″ of the other two third rows 26″ and 24″ are also respectively aligned edge to edge.

Therefore, by fastening the three times two intermediate flanges 50″, which are aligned edge to edge, of the three third rows 24″, 26″ and 28″ to the third bottom 14″ of the third casing 12″, two parallel rigid transverse elements are then formed.

There will now be described, with reference to the figures [FIG. 4] and [FIG. 5], methods of fastening the flanges to the bottom of the casing, according to two variant embodiments.

Thus, the figure [FIG. 4] shows a single intermediate flange 50″ in cross section. It has a rectangular parallelepipedal overall shape, i.e. two opposite large sides 52, 54, and two opposite small sides 56, 58. It also has a thickness e illustrated in the figure [FIG. 3] and corresponding to an edge face. It is for example molded in one piece from aluminum alloy. Also, the intermediate flange 50″ has two parallel orifices 60, 62, provided at a distance from one another in its thickness e and perpendicular to the two opposite large sides 52, 54 into which they respectively open. In this way, the intermediate flange 50″ is mounted vertically with one of its large sides 52 resting against the third bottom 14″ of the third casing 12″, and it is held there in a fixed position by virtue of two screws 64, 66 respectively engaged in the two orifices 60, 62 and screwed into two tapped portions 68, 70 made in the bottom wall 14″. The two screws 64, 66 respectively have two heads 72, 74 that are applied against the edge face of the other, opposite, large side 54 so as to hold the intermediate flange 50″ in a fixed position against the bottom wall 14″.

In this way, the intermediate flanges 50″ as shown in the figure [FIG. 3], three aligned along line L1 and three aligned along line L2, are respectively held in a fixed position in the extension of one another with their small sides 56, 58 next to one another or in contact, i.e. respectively edge to edge.

According to another variant embodiment illustrated in the figure [FIG. 5], in which the elements identical to those in the figure [FIG. 2] or having the same function bear the same reference followed by a “′″” symbol, the bottom wall 14′″ is equipped with two tapped collars 68″, 70′″ making it possible to receive the screws 64″, 66″, while the large side 52″ resting against the bottom wall 14″ has recesses 80, 82 in the extension of the orifices 60′″, 62″ so as to accommodate the tapped collars 76, 78. Such a variant embodiment makes it possible to reduce the thickness of the bottom wall so as to reduce the bulk and the weight of the electrical power supply assembly in accordance with the invention.

1-10. (canceled)

11. An electrical power supply assembly for a motor vehicle, comprising:
a casing having a bottom and at least two lateral walls that are opposite one another and protrude upright from said bottom; and
a set of accumulator battery modules, each of the modules of said set having an accumulator battery having two opposite ends, and two opposite flanges respectively covering said ends, the modules of said set being installed inside said casing on said bottom in a plurality of contiguous rows of n modules situated coaxially in an extension of one another and substantially parallel to said lateral walls,
wherein said contiguous rows are arranged such that the flanges of the modules of said rows are respectively aligned edge to edge in a direction substantially perpendicular to said opposite lateral walls and
wherein said aligned flanges are secured to said bottom of said casing so as to form rigid crossmembers inside said casing.

12. The electrical power supply assembly as claimed in claim 11, wherein the modules of each of said rows are connected together in pairs by just a single flange.

13. The electrical power supply assembly as claimed in claim 11, wherein said modules of said set of modules have just a single length.

14. The electrical power supply assembly as claimed in claim 11, wherein said casing has a front wall and an opposite rear wall, protruding upright from said bottom and respectively connecting said lateral walls substantially perpendicularly so as to close said casing.

15. The electrical power supply assembly as claimed in claim 11, wherein each of said flanges has a given thickness and at least one through-orifice made in said thickness so as to allow a fastening screw to pass through.

16. The electrical power supply assembly as claimed in claim 15, wherein said bottom of said casing has tapped portions for receiving the screws for fastening said flanges.

17. The electrical power supply assembly as claimed in claim 15, wherein said bottom of said casing comprises tapped collars for receiving said fastening screws.

18. The electrical power supply assembly as claimed in claim 17, wherein said flanges have recesses in an extension of said through-orifices so as to accommodate said collars.

19. The electrical power supply assembly as claimed in claim 11, wherein each of said flanges has a substantially rectangular parallelepipedal shape.

20. The electrical power supply assembly as claimed in claim 11, wherein each of said flanges is molded in one piece from aluminum alloy.
